(19) United States
(12) Patent Application Publication
(10) Pub. No.: US 2020/0118215 A1
(43) Pub. Date: Apr. 16, 2020

(54) DYNAMIC PRICING OF INSURANCE POLICIES FOR SHARED GOODS

(71) Applicant: DigiSure, Inc., Burlingame, CA (US)

(72) Inventors: Praveen RAO, San Francisco, CA (US); Michael Seungwook SHIM, Burlingame, CA (US); Paul Charles SMITH, Oakland, CA (US)

(21) Appl. No.: 16/159,176

(22) Filed: Oct. 12, 2018

(51) Int. Cl. G06Q 40/08; G06Q 30/02

(52) U.S. Cl. CPC G06Q 40/08; G06Q 30/0282; G06Q 30/0206

(57) ABSTRACT

Introduced here are risk management platforms able to provide a variety of insurance services related to the sharing economy. The risk management platforms can collect/leverage data from an array of different sources, dynamically calculate an appropriate personalized price (e.g., for an insurance policy) based on risk, mitigate potential fraud, offer end-to-end digital servicing, etc.

### TECHNICAL FIELD

Various embodiments concern computer programs and associated computer-implemented techniques for providing insurance services related to goods that are involved in peer-to-peer rental transactions.

### BACKGROUND

The term “sharing economy” refers to an economic model that emphasizes collaborative consumption of resources. In a sharing economy (also referred to as a “collaborative economy” or a “peer economy”), consumers collaboratively consume resources. Thus, each consumer can occupy a two-sided role, in which she may act as a provider of resources or an obtainer of resources.

By facilitating peer-to-peer sharing of access to goods, providers have increased the value of these goods. Examples of providers include Airbnb®, Turo®, Getaround®, Outdoorsy®, and boatsetter®. Transactions are often completed using an online marketplace (e.g., in the form of a website, mobile application, etc.) associated with a given provider. When information about a good is shared via the online marketplace, the value of the good may increase for the owner, other individuals, and society in general.

Insurance companies, however, have been unable to properly account for the unique risks created by sharing economies. For example, most insurance policies (e.g., those for real estate and motor vehicles) do not cover regular commercial activity. While providers may offer owners/consumers limited coverage, the amount of coverage offered is typically not enough should something happen. When a loss is not sufficiently covered by the limited coverage extended by a provider, individual policy holders (e.g., the owner and the consumer) are left to assume the risk, which could be substantial. Insurance policies covering regular commercial activity, meanwhile, are generally prohibitively expensive for individual policy holders to acquire.

### BRIEF DESCRIPTION OF THE DRAWINGS

Various features of the technology will become more apparent to those skilled in the art from a study of the Detailed Description in conjunction with the drawings. Embodiments of the technology are illustrated by way of example and not limitation in the drawings, in which like references may indicate similar elements.

FIG. 1A illustrates how conventional insurance solutions will often offer indiscriminate pricing regardless of the risk associated with individual policyholders.

FIG. 1B illustrates how the risk management platforms described herein can offer individualized pricing based on the risk associated with each renter.

FIG. 2 illustrates a network environment that includes a risk management platform.

FIG. 3 depicts the high-level architecture of a risk management platform able to leverage data to generate personalized trust scores, reputation scores, and/or risk scores (collectively referred to as “scores”) to power efficient, protected transactions across sharing economy marketplaces.

FIG. 4 depicts examples of the interfaces which a renter may be shown while completing the process for finalizing a rental of a sharable good.

FIG. 5 depicts an example of a communication environment that includes a risk management platform configured to collect data from one or more different sources.

FIG. 6A includes a generalized illustration of a process for generating scores indicative of risk, and then improving how the scores are calculated over time.

FIG. 6B includes three examples of profiles produced for the same prospective renter.

FIG. 7A includes a generalized illustration of a process for facilitating the completion of a rental transaction.

FIG. 7B depicts an example of a process for registering for a rental service, and then reserving a good available through the rental service.

FIG. 8 illustrates how services offered by a risk management platform may be offered as a Product-as-a-Service (PaaS) or Software-as-a-Service (SaaS).

FIG. 9 depicts an example of a communication environment that includes a risk management platform with which individuals (e.g., prospective renters, owners, and/or administrators) may interact.

FIG. 10 illustrates how a risk management platform can generate a score for a prospective renter indicative of risk in renting a good to the prospective renter by separately weighing a series of risk factors.

FIG. 11 is a block diagram illustrating an example of a processing system in which at least some operations described herein can be implemented.

The drawings depict various embodiments for the purpose of illustration only. Those skilled in the art will recognize that alternative embodiments may be employed without departing from the principles of the technology. Accordingly, while specific embodiments are shown in the drawings, the technology is amenable to various modifications.

### DETAILED DESCRIPTION

In a sharing economy, consumers can collaboratively consume resources by occupying a two-sided role, in which each consumer may act as a provider of resources and/or an obtainer of resources. A provider will often be responsible for facilitating peer-to-peer sharing of access to goods. Transactions can be completed using an online marketplace associated with a given provider. The online marketplace may be accessible via a website, mobile application, etc.

Insurance companies, however, have been unable to properly account for the unique risks created by sharing economies. For example, most insurance policies (e.g., those for real estate and motor vehicles) do not cover regular commercial activity. While providers may offer owners/consumers limited coverage, the amount of coverage offered is typically not enough should something happen. When a loss is not sufficiently covered by the limited coverage extended by a provider, individual policy holders (e.g., the owner and the consumer) are left to assume the risk, which could be substantial. Insurance policies covering regular commercial activity, meanwhile, are generally prohibitively expensive for individual policy holders to acquire.

The lack of innovation in insurance policies has created several risks to those involved in the sharing economy. First, owners and consumers generally misunderstand the coverage of conventional insurance policies. Second, expensive insurance policies designed to cover commercial activities limit marketplace growth. Third, conventional insurance policies may mask personal risk involved in peer-to-peer sharing, thereby causing the personal risk to be underappreciated by owners and consumers.

Introduced here, therefore, are risk management platforms able to provide a variety of insurance services related to the sharing economy. The risk management platforms can collect/leverage data from an array of different sources, dynamically calculate an appropriate personalized price (e.g., for an insurance policy) based on risk, mitigate potential fraud, offer end-to-end digital servicing, etc. Because these insurance services are related to goods offered for rent via the sharing economy, they may be temporary in nature. For example, customized insurance policies offered by the risk management platform may cover a short-term interval of time (e.g., days, weeks, or months).

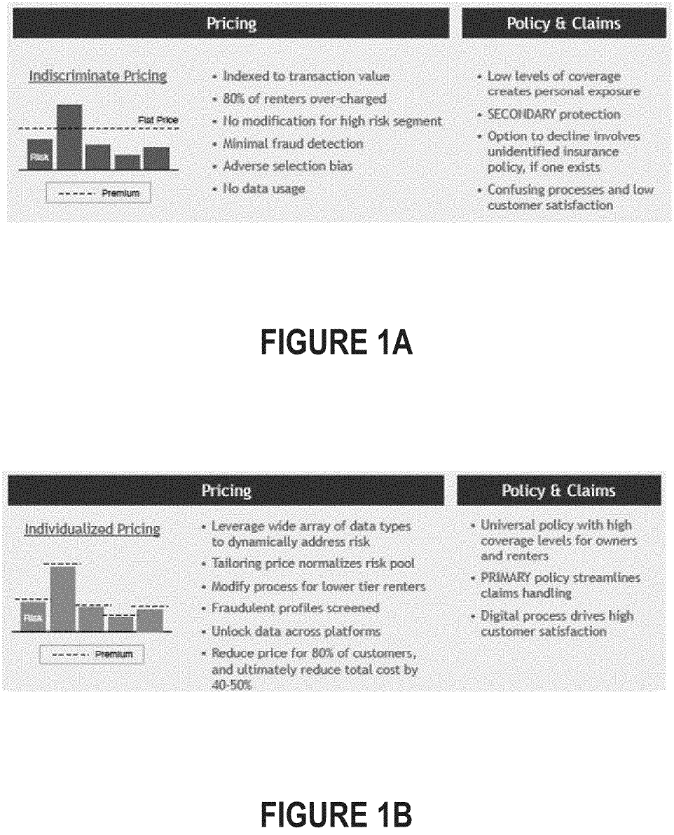

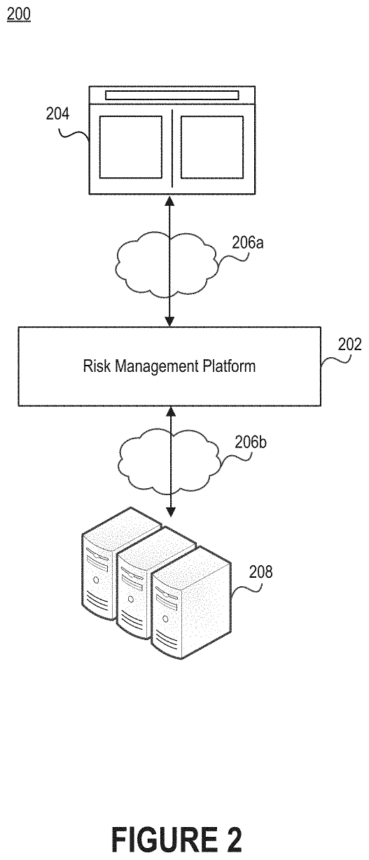

As shown in FIG. 1A, conventional insurance solutions will often offer indiscriminate pricing regardless of the risk associated with individual policyholders. Premiums have historically been indexed to transaction value, which causes the vast majority of good renters to be overcharged in some markets (e.g., peer-to-peer rentals of motor vehicles, peer-to-peer rentals of real estate). These overcharges are largely due to the lack of modification for higher-risk renters. Said another way, because conventional sharing economy insurance solutions are not personalized solutions (e.g., cannot increase the price for high-risk renters and/or decrease the price for low-risk renters), all renters in the corresponding market will typically pay higher prices to guard against the risk imposed by certain individuals.

The risk management platforms described herein, however, can offer individualized pricing based on the risk associated with each renter, as shown in FIG. 1B. More specifically, by leveraging a wide array of data inputs, a risk management platform can dynamically address the risk associated with a given rental transaction, and then tailor the price accordingly to normalize the risk pool across a series of rental transactions. Such action can serve to reduce the price for a majority of customers that are currently active in the sharing economy ecosystem.

Embodiments may be described with reference to particular computer programs, system configurations, networks, etc. However, those skilled in the art will recognize that these features are equally applicable to other computer program types, system configurations, network types, etc. For example, although the term “mobile application” may be used to describe a computer program, the relevant feature may be embodied in another type of computer program.

Embodiments may also be described in the context of generating scores indicative of risk for renters of shared goods. However, the same features may be applicable to generating scores indicative of risk for owners of the shared goods. Thus, a risk management platform may identify an appropriate, personalized insurance solution for a transaction involving a shared good based on the risk associated with the renter, the risk associated with the owner, or both.

Moreover, the technology can be embodied using special-purpose hardware (e.g., circuitry), programmable circuitry appropriately programmed with software and/or firmware, or a combination of special-purpose hardware and programmable circuitry. Accordingly, embodiments may include a machine-readable medium having instructions that may be used to program a computing device to perform a process for acquiring data associated with a given renter from at least one source, estimating the risk of a rental transaction based on the data, calculating a price for the rental transaction based on the estimated risk, etc. Moreover, machine learning algorithms and/or artificial intelligence algorithms may be applied to further optimize the process over time. For example, the price for a subsequent transaction may be based on whether the given renter returned the rented good on time, in good condition, etc.

### Terminology

References in this description to “an embodiment” or “one embodiment” means that the particular feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the words “comprise” and “comprising” are to be construed in an inclusive sense rather than an exclusive or exhaustive sense (i.e., in the sense of “including but not limited to”). The terms “connected,” “coupled,” or any variant thereof is intended to include any connection or coupling between two or more elements, either direct or indirect. The coupling/connection can be physical, logical, or a combination thereof. For example, devices may be electrically or communicatively coupled to one another despite not sharing a physical connection.

The term “based on” is also to be construed in an inclusive sense rather than an exclusive or exhaustive sense. Thus, unless otherwise noted, the term “based on” is intended to mean “based at least in part on.”

The term “module” refers broadly to software components, hardware components, and/or firmware components. Modules are typically functional components that can generate useful data or other output(s) based on specified input(s). A module may be self-contained. A computer program may include one or more modules. Thus, a computer program may include multiple modules responsible for completing different tasks or a single module responsible for completing all tasks.

When used in reference to a list of multiple items, the word “or” is intended to cover all of the following interpretations: any of the items in the list, all of the items in the list, and any combination of items in the list.

The sequences of steps performed in any of the processes described here are exemplary. However, unless contrary to physical possibility, the steps may be performed in various sequences and combinations. For example, steps could be added to, or removed from, the processes described here. Similarly, steps could be replaced or reordered. Thus, descriptions of any processes are intended to be open-ended.

### Technology Overview

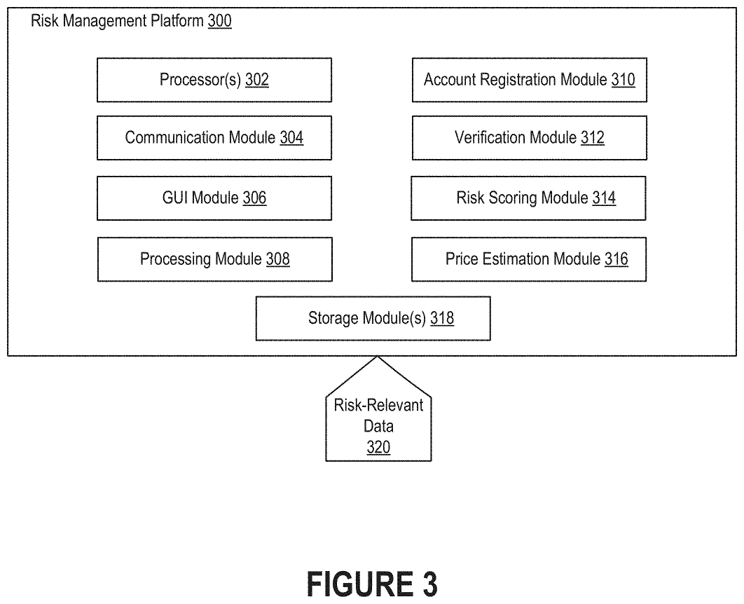

FIG. 2 illustrates a network environment 200 that includes a risk management platform 202. Individuals can interface with the risk management platform 202 via an interface 204. The risk management platform 202 may be responsible for parsing data related to the renter, estimating the risk of a rental transaction involving the renter based on the data, and calculating a price for the rental transaction based on the estimated risk. Thus, a renter may access the interface 204 to browse goods available for rent. Then, upon identifying a good she wishes to rent, the renter may access the interface 204 to review a proposed quote, examine/negotiate terms, and complete the transaction. The risk management platform 202 may also be responsible for creating interfaces through which the individual can communicate with others (e.g., administrators of insurance policies), file claims, review a personalized risk profile generated by the risk management platform 202, manage preferences, etc.

The data acquired by the risk management platform 202 could pertain to characteristics associated with individuals accessing the interface 204 or some other person. For example, in some embodiments the interface 204 enables a person who is interested in renting a good to view a risk estimation that is based on her own data (or analysis of such data), while in other embodiments the interface 204 an individual to view data (or analysis of such data) associated with some other person. The individual may be an owner interested in making a good available for rent or an administrator associated with the risk management platform 202. Examples of administrators include insurance agents, claims handlers, etc. Some interfaces are configured to facilitate interactions between renters and owners, renters and administrators, or owners and administrators. Other interfaces are configured to serve as informative dashboards for renters, owners, or administrators.

As noted above, the risk management platform 202 may reside in a network environment 200. Thus, the risk management platform 202 may be connected to one or more networks 206a-b. The network(s) 206a-b can include personal area networks (PANs), local area networks (LANs), wide area networks (WANs), metropolitan area networks (MANs), cellular networks, the Internet, etc. Additionally or alternatively, the risk management platform 102 can be communicatively coupled to computing device(s) over a short-range communication protocol, such as Bluetooth® or Near Field Communication (NFC).

The interface 204 is preferably accessible via a web browser, desktop application, mobile application, or over-the-top (OTT) application. Accordingly, the interface 204 may be viewed on a personal computer, tablet computer, personal digital assistant (PDA), mobile phone, game console, music player, wearable electronic device (e.g., a watch or fitness accessory), network-connected (“smart”) electronic device, (e.g., a television or home assistant device), virtual/augmented reality system (e.g., a head-mounted display), or some other electronic device.

Some embodiments of the risk management platform 202 are hosted locally. That is, the risk management platform 202 may reside on the computing device used to access the interface 204. For example, the risk management platform 202 may be embodied as a mobile application executing on a mobile phone. Other embodiments of the risk management platform 202 are executed by a cloud computing service operated by Amazon Web Services® (AWS), Google Cloud Platform™, Microsoft Azure®, or a similar technology. In such embodiments, the risk management platform 202 may reside on a host computer server that is communicatively coupled to one or more content computer servers 208. The content computer server(s) 208 can include information regarding rentable goods, models for calculating the cost of personalized policies, user information (e.g., profiles, credentials, and insurance-related information such as age, accident history, location, etc.), and other assets. Such information could also be stored on the host computer server.

Certain embodiments are described in the context of network-accessible interfaces. However, those skilled in the art will recognize that the interfaces need not necessarily be accessible via a network. For example, a computing device may be configured to execute a self-contained computer program that does not require network access. Instead, the self-contained computer program may cause necessary assets (e.g., data associated with a perspective renter, risk assessment models, pricing models, or processing operations) to be downloaded at a single point in time or on a periodic basis (e.g., weekly, daily, or hourly).

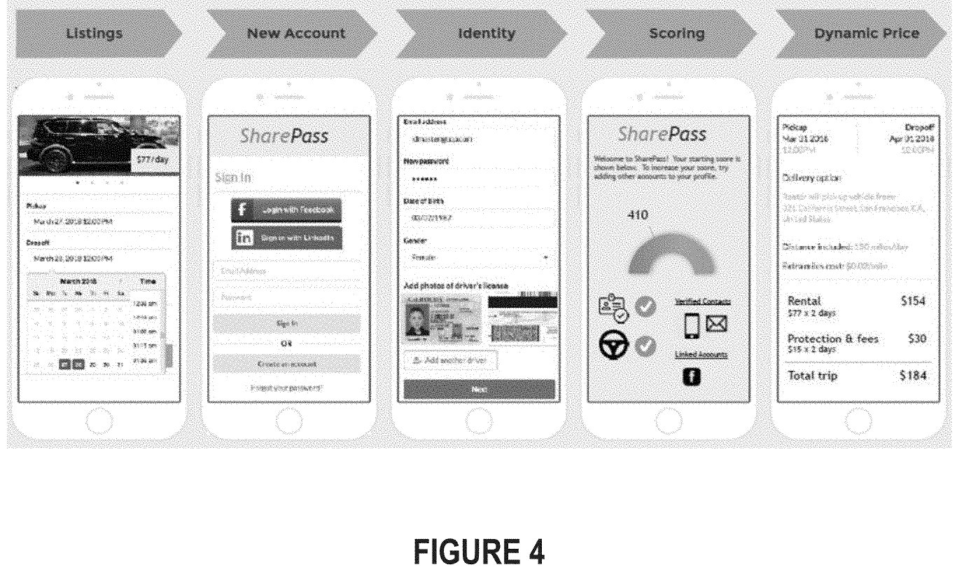

FIG. 3 depicts the high-level architecture of a risk management platform 300 able to leverage data to generate personalized trust scores, reputation scores, and/or risk scores (collectively referred to as “scores”) to power efficient, protected transactions across scaring economy marketplaces. The risk management platform 300 may use these personalized scores to calculate the appropriate price for coverage on an individual basis. Moreover, these personalized scores may be inherently portable. For instance, the personalized scores may be shared across different sharing-focused marketplaces that make use of the risk management platform 300. Additionally, the personalized scores may be sharable between individuals independent of sharing-focused marketplaces. Thus, the personalized scores may be readily sharable as proof of trustworthiness.

As shown in FIG. 2, an individual can interface with the risk management platform 300 via an interface. The individual may be an owner of a sharable good, a prospective renter of the sharable good, or an administrator associated with the risk management platform 300. The risk management platform 300 can include one or more processors 302, a communication module 304, a graphical user interface (GUI) module 306, a processing module 308, an account registration module 310, a verification module 312, a risk scoring module 314, a price estimation module 316, and one or more storage modules 318. In some embodiments a single storage module includes multiple computer programs for performing different operations (e.g., metadata extraction, format conversion, and feature analysis), while in other embodiments each computer program is hosted within a separate storage module. Embodiments of the risk management platform 300 may include some or all of these components, as well as other components not shown here.

The processor(s) 302 can execute modules from instructions stored in the storage module(s) 318, which can be any device or mechanism capable of storing information. For example, the processor(s) 302 may execute the GUI module 306, processing module 308, account registration module 310, verification module 312, risk scoring module 314, and price estimation module 316.

The communication module 304 can manage communications between various components of the risk management platform 300. The communication module 304 can also manage communications between the computing device on which the risk management platform 300 resides and another computing device.

For example, the risk management platform 300 may reside on a mobile phone in the form of a mobile application. In such embodiments, the communication module 304 can facilitate communication with a network-accessible computer server responsible for supporting the mobile application. The communication module 304 may facilitate communication with various data sources through the use of application programming interfaces (APIs), bulk data interfaces, etc. Examples of data sources include network-accessible databases, other mobile applications residing on the mobile phone, etc.

As another example, the risk management platform 300 may reside on a server system that includes one or more network-accessible computer servers. In such embodiments, the communication module 304 can communicate with a computer program executing on the computing device associated with the individual. Those skilled in the art will recognize that the components of the risk management platform 300 can be distributed between the server system and the computing device associated with the individual in various manners. For example, some information may reside on the computing device of the individual, while other data may reside on the server system.

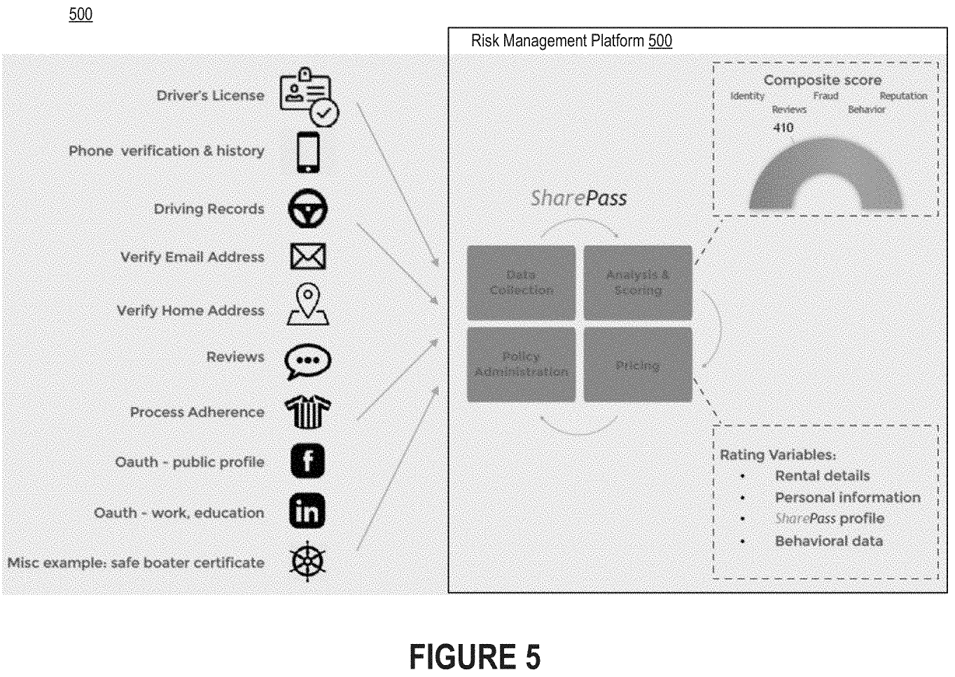

The GUI module 306 can generate the interface(s) through which an individual can interact with the risk management platform 300. For example, an interface may include visual representations of goods available for rent. As another example, an interface may include a series of fields in which the individual can input information useful for generating personalized insurance policies, such as name, date of birth, gender, etc. Several examples of interfaces are shown in FIG. 4.

The processing module 208 can apply one or more operations to risk-relevant data 320 acquired by the risk management platform 300. As further described below, the risk-relevant data 320 could be acquired from one or more sources. Examples of sources include the computing device on which the risk management platform 300 resides, a computer program executing on the computing device, and some other computing device (e.g., a network-accessible computer server). The risk-relevant data 320 may include information about a prospective renter, such as the personal data (e.g., driver's license, driving records, email address, physical address), usage history, claims history, ownership history, publicly available information (e.g., court information and arrest records), social network data (e.g., derived from profiles on social networking platforms, such as Facebook®, LinkedIn®, etc.), third-party-collected data, indicators of process adherence, past rental reviews, etc. Risk-relevant data 320 will often be acquired by the risk management platform 300 from multiple sources. Thus, the processing module 308 may apply operation(s) to the risk-relevant data 320 to ensure that data acquired from multiple sources is in a compatible format, pertains to the same individual, etc.

A source may be configured to continuously or periodically transmit risk-relevant data 320 to the risk management platform 300. In some embodiments, the source continually uploads risk-relevant data 320 to the risk management platform 300 so long as the source remains communicatively coupled to the computing device on which the risk management platform 300 resides. For example, driving records may be automatically acquired by the risk management platform 300 each time a change is made. As another example, public information may be derived from an account with a social networking platform each time a prospective renter indicates an interest in renting a good. In other embodiments, the source uploads risk-relevant data 320 to the risk management platform 300 on a periodic basis (e.g., hourly, daily, or weekly). The risk management platform 300 can be configured to pull risk-relevant data 320 from the source. Additionally or alternatively, the source can be configured to push risk-relevant data 320 to the risk management platform 300. In some embodiments, owners, renters, and administrators are able to configure these push/pull settings. These settings can be configured on an individual basis or group basis (e.g., for multiple renters associated with a certain market segment, such as real estate, boats, or recreational vehicles).

The processing module 308 can process the risk-relevant data 320 into a format suitable for the other modules (e.g., the account registration module 310, verification module 312, risk scoring module 314, price estimation module 316, or storage module(s) 318). The processing module 308 can also parse the risk-relevant data 320 to identify the individual with which the risk-relevant data 320 should be associated. For example, the processing module 308 may identify the individual by parsing the risk-relevant data 320 to discover a feature indicative of the individual (e.g., an identifier or characteristic conveyed by metadata). Additionally or alternatively, the processing module 308 may discover the risk-relevant data 320 is associated with the individual based on the source responsible for providing the risk-relevant data 320 (e.g., a computer program that provides the risk-relevant data 320 may know the individual is currently signed in).

The account registration module 310 can process information related to an individual (e.g., an owner or renter) who accesses an interface generated by the GUI module 306 to create an account with the risk management platform 300. For example, upon parsing the information, the account registration module 310 may populate an entry in an account database with details regarding the individual. Examples of such details include an identifier (e.g., an email address, phone number, or account name), password, date of birth, gender, physical address, etc. In some embodiments, at least some of the information is provided by the individual as input through the interface (e.g., by filling out a series of elements on a form). In other embodiments, at least some of the information is automatically derived on behalf of the individual (e.g., by scraping the information from a social networking account known to be associated with the individual).

The verification module 312 may be responsible for verifying inputs provided via interfaces generated by the GUI module 306 (or acquired via some other manner). Verification may be necessary for a variety of different types of inputs. Examples include the individual herself, the computing device used to access the interfaces, credit, geography, human behavior, connections between two of more categories, etc. Thus, the upon receiving input indicative of registration information being entered into an interface, the verification module 312 may initiate a verification process. For example, the verification module 312 may cause a personal identification number (PIN) to be delivered to a computing device to see whether the individual has control of the computing device. The PIN may be delivered via a push notification, email, text message, etc. Then, after receiving input indicative of user input of the PIN, the verification module 312 can specify (e.g., in the database entry for the corresponding account) that the computing device is a trusted device. Conversely, if no input indicative of user input of the PIN is received, the verification module 312 may specify that the computing device is not a trusted device.

The risk scoring module 314 (also referred to as a “risk decision engine” or “risk assessment engine”) can generate a personalized score indicative of the risk involved in a sharing transaction involving a given individual. For example, a renter may initially browse sharable goods shown on an interface generated by the GUI module 306. Thereafter, the renter may select a good that she wishes to rent for a specified period of time. Upon receiving input specifying the selected good, the risk scoring module 314 can generate a score that represents the risk associated with the rental of the selected good to the renter. As further described below, the score can be based on weighted information derived from the risk-relevant data. In some embodiments, the score is also based on the selected good. For instance, scores for a certain type of good (e.g., motor vehicles) will generally increase if the renter has shown an inability to return this type of good in suitable condition, on time, etc. Additionally or alternatively, the risk scoring module 314 may generate a score that represents the risk associated with the owner of the selected good. Accordingly, in some embodiments the risk scoring module 314 only generates scores for a subset of the individuals involved in a sharing transaction, while in other embodiments the risk scoring module 314 generates scores for all individuals involved in a sharing transaction.

The price estimation module 316, meanwhile, can generate prices, on a per-rental-transaction basis, based on the score(s) generated by the risk scoring module 314. Consequently, the price generated for a rental transaction may be based on the risk associated with the renter, the risk associated with the owner, or some combination thereof. For instance, the risk associated with the renter may be weighted more heavily in some rental transactions (e.g., those involving expensive items, such as vehicles and real estate) than the risk associated with the owner. Rather than impose the same cost on each renter in a particular market segment, the price estimation module 316 can instead dynamically calculate a price for each rental transaction based on the risk associated with the corresponding renter. Said another way, the price associated with a rental transaction may be personalized for each individual. Moreover, an individual may be associated with different prices for different goods within a single category, so price generation is more dynamic in nature. For example, a renter who opts to rent a sedan may be given a different price than if she had chosen to rent a sport utility vehicle (SUV) or sports car, even if other characteristics of the rental transaction, such as duration, remain roughly the same. Accordingly, price generation may be dynamic not only on an individual level, but also on other dimensions such as good type, geography, time of day, rental length, etc.

The risk management platform 300 may include other modules in addition to those described above. For example, the risk management platform 300 may include modules for monitoring asset listings (e.g., as part of a reservation platform or booking platform), telematics, customer support (e.g., as part of a digital customer service platform), reservation management, reviews, roadside assistance, claims management, fraud detection, etc.

FIG. 4 depicts examples of the interfaces which a renter may be shown while completing the process for finalizing a rental of a sharable good. While FIG. 4 is described in the context of a motor vehicle, those skilled in the art will recognize that similar interfaces may be shown to renters interested in other sharable goods, such as real estate, boats, etc.

Initially, a prospective renter may browse listings of sharable goods available via a risk management platform. After selecting a good, the prospective renter may be permitted to specify the interval of time over which she would like to rent the good. Here, for example, the prospective renter is able to select dates/times from a calendar. However, the interface may also permit the prospective renter to specify a rental duration (e.g., a day, week, or month).

In some embodiments, the risk management platform generates an interface that prompts the prospective renter to either log into an existing account or create a new account. As shown here, the prospective may have the option of either creating an account exclusive to the risk management platform (e.g., by specifying an identifier and password) or using an existing account with, for example, a social networking platform. Some embodiments of the risk management platform require that the prospective renter sign into an account before browsing the listings, while other embodiments of the risk management platform require that the prospective renter sign into an account before completing the rental transaction.

The risk management platform can then verify the identity of the prospective renter. For example, the prospective renter may be prompted to upload an official document (e.g., an image of her driver's license) for verification, which can then be remotely authenticated utilizing a third-party service, the risk management platform itself, or some combination thereof. As shown in FIG. 4, the prospective renter may also be prompted to input other information that can be verified. For example, contact information provided by the prospective renter may be used to ensure the prospective renter actually has possession of the computing device used to interface with the risk management platform. As another example, the risk management platform may ensure that a physical address input by the prospective renter is actually a valid address.

In some embodiments, the risk management platform causes display of a visual representation indicative of risk associated with the prospective renter. Here, for example, the visual representation illustrates where the risk lies between a minimum risk level and a maximum risk level. The risk management platform may also cause display of other visual elements indicating how the risk was established, how the risk could be lessened, etc. Here, for example, separate visual elements are included to show that the risk management platform has successfully acquired information regarding the prospective renter's driver's license and driving records.

After selecting a good, the risk management platform may cause display of a personalized price that is based on the risk associated with the prospective renter. Here, the total cost for renting the good for two days is $184. However, the total cost for another prospective renter with lower risk may be less. Similarly, the total cost for another prospective renter with higher risk may be more.

In some embodiments, the personalized prices generated by the risk management platform are dynamically assessed over time. For example, when the prospective renter selects the good, the risk management platform may generate an initial price (also referred to as a “time-of-transaction price”). As the rental transaction progresses, the risk management platform may continue evaluating risk and, if appropriate, provide feedback to the renter. The feedback may specify that good behavior (e.g., returning the good in its original condition) will be rewarded with a pricing discount following the conclusion of the rental transaction, reward points for a loyalty program, a pricing discount for the next rental transaction, etc.

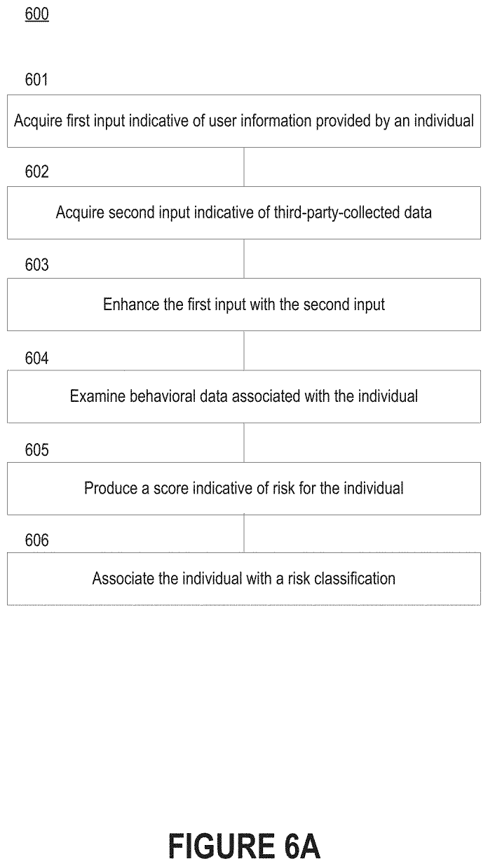

FIG. 5 depicts an example of a communication environment 500 that includes a risk management platform 502 configured to collect data from one or more different sources. Examples of such data include personal data (e.g., driver's license, driving records, email address, physical address), usage history, claims history, ownership history, publicly available information (e.g., court information and arrest records), social network data (e.g., derived from profiles on social networking platforms, such as Facebook®, LinkedIn®, etc.), third-party-collected data, indicators of process adherence, past rental reviews, etc. Those skilled in the art will recognize that any subset of the different types of information could be used to produce personalized cost estimates.

Each source can be connected to the risk management platform 502 via one or more networks (not shown). The networks can include PANs, LANs, WANs, MANs, cellular networks, the Internet, etc. Additionally or alternatively, the sources may communicate with the risk management platform 502 over a short-range communication protocol, such as Bluetooth® or Near Field Communication (NFC). For example, the risk management platform 502 may reside on a mobile phone (e.g., in the form of a mobile application) that is associated with a prospective renter. In such embodiments, data received from the mobile phone need not traverse any networks. For example, the risk management platform 502 may acquire some information directly from a social networking mobile application that also resides on the mobile phone.

Embodiments of the communication environment 500 may be configured to facilitate the retrieval of some or all of the types of data shown here. For example, some embodiments of the communication environment 500 include a risk management platform 502 that acquires data from at least one network-accessible server and the mobile phone on which the risk management platform 502 resides. As another example, some embodiments of the communication environment include a risk management platform 502 that only receives data from at least one network-accessible server.

After collecting data from the source(s), the risk management platform 502 can analyze the data to predict a score for each prospective renter. To owners of sharable goods, the score may be viewed as a good approximation of the risk associated with renting to these prospective renters. The risk management platform 502 may also generate personalized insurance policies based on the scores. In some embodiments, other information is also considered when generating the personalized insurance policies. For example, the risk management platform 502 may consider rental details (e.g., the type/value of a good being rented, the duration of the rental, etc.), personal information (e.g., the age, gender, or location of the prospective renter), behavioral information (e.g., whether the prospective renter has historically returned rented goods on time, in good condition, etc.), etc.

Moreover, after collecting data from the source(s), the risk management platform 502 can analyze the data to predict a score for each prospective owner. In some embodiments these scores are viewable by prospective renters, while in other embodiments are hidden from prospective renters. By verifying each owner (and producing a corresponding score indicative of risk), the risk management platform 502 can ensure that providers can determine which owner(s) to bring on as participants. For instance, a provider responsible for facilitating rentals of RVs may choose to only list owners having a score that meets a certain threshold. Such action allows the provider to ensure that all sharing transactions involve reputable, verified owners.

In some embodiments, the risk management platform 502 may also facilitate the administration of these personalized insurance policies. For example, in addition to interacting with the risk management platform 502 to complete a rental transaction, a renter (or the owner) may interact with the risk management platform 502 to negotiate terms of the coverage, file a claim, request roadside assistance, etc.

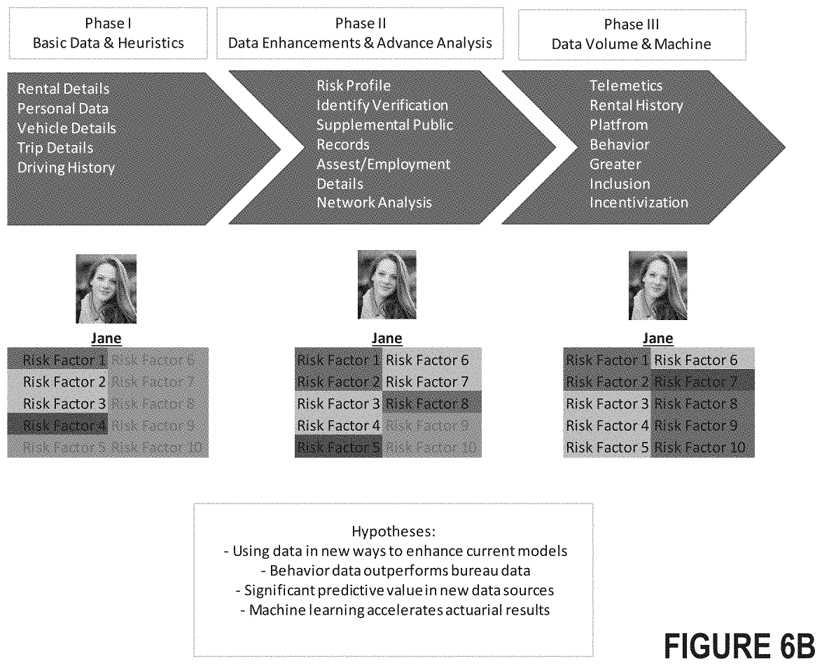

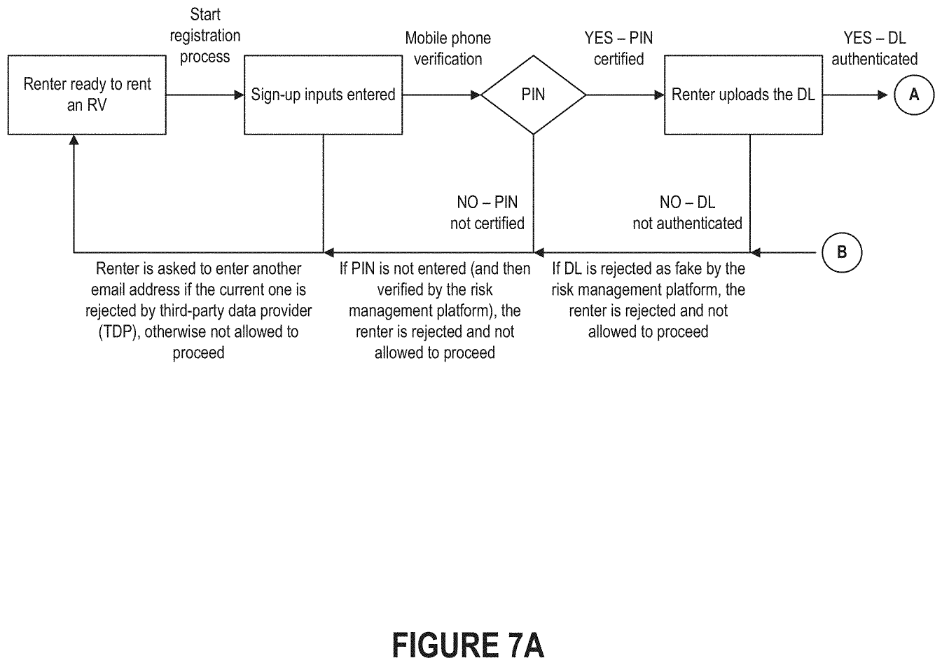

FIG. 6 includes a generalized illustration of a process for generating scores indicative of risk for several individuals (e.g., prospective renters), and then improving how the scores are calculated over time.

Initially, a risk management platform acquires risk-relevant data (also referred to as “basic data”) from at least one source that is external to the risk management platform. Examples of basic data include, among others, rental details, personal data (e.g., driver's license, driving records, email address, physical address), usage history, claims history, ownership history, publicly available information (e.g., court information and arrest records), social network data (e.g., derived from profiles on social networking platforms, such as Facebook®, LinkedIn®, etc.), third-party-collected data, indicators of process adherence, and past rental reviews. The risk management platform can then apply a series of heuristics to produce a score for each individual. Generally, these individuals are prospective renters of goods available for rental through the risk management platform or another platform to which the risk management platform is connected. Thus, the score may be indicative of the riskiness of renting a good to each individual, at least with respect to the other individuals who have an account with the risk management platform.

FIG. 6A includes a generalized illustration of a process 600 for generating scores indicative of risk, and then improving how the scores are calculated over time. A risk management platform can acquire first input indicative of user information provided by an individual (step 601). The first input may be acquired, for example, via a user interface that is accessible to the individual. The individual may be either an owner of a good to be shared amongst renters or a prospective renter interested in renting a good. The risk management platform may also acquire second input indicative of third-party-collected data (step 602). The second input may be acquired by interfacing with a third-party service (e.g., via an application programming interface).

Thereafter, the risk management platform can enhance the first input with the second input (step 603). By combining these disparate data, the risk management platform can better understand the overall risk presented by the individual. For example, the risk management platform may generate a user profile designed to effectively store these disparate data in a manner that lends itself to further analysis (e.g., when a personalized price estimate is needed for a transaction involving the individual). After generating the user profile, the risk management platform may store the user profile in a database. The database may be associated with a provider, customer role (e.g., owner or renter), etc.

In some embodiments, the risk management platform also examines behavioral data associated with the individual (step 604). Generally, the behavioral data is indicative of activities/outcomes that are relevant in determining the likelihood that a rental transaction will be completed without issue. For example, if the individual is a prospective renter, the behavioral data may specify whether the individual has historically returned rented goods on time, in good condition, etc. As another example, if the individual is an owner, the behavioral data may specify whether the individual has historically submitted complaints following rentals of her good(s), the condition of the good(s), etc.

By considering the first input, second input, and behavioral data, the risk management can produce a score indicative of the risk associated with the individual (step 605). The risk management platform can then associate the individual with a risk classification based on the score (step 606). In some embodiments, the appropriate risk classification is identified based on a comparison of the score with a series of predetermined thresholds. For instance, individuals having scores above 700 may be considered low-risk customers, individuals having scores from 300-700 may be considered moderate-risk customers, and individuals having scores lower than 300 may be considered high-risk customers. Alternatively, the appropriate risk classification may be determined by stratifying a pool of customers. For instance, individuals having scores in the first quartile may be considered high-risk customers, individuals having scores in the second and third quartiles may be considered moderate-risk customers, and individuals having scores in the fourth quartiles may be considered low-risk customers.

Unless contrary to physical possibility, it is envisioned that the steps described above may be performed in various sequences and combinations. For example, the first and second input may be acquired sequentially or successively. Other steps may also be included in some embodiments. For example, the risk management platform may specify the risk classification in the user profile associated with the individual. Moreover, the process 600 may be performed periodically over time to ensure that individuals can move amongst the risk classifications (e.g., from high risk to moderate risk, or vice versa) as additional information is collected over time.

FIG. 6B includes three examples of profiles produced for the same prospective renter. The risk management platform may rate the individual in a series of different categories during each phase of a risk analysis process. Here, for example, the risk analysis process includes three phases. In the first phase, data associated with the individual may be acquired by a risk management platform. The data may pertain, for example, to rental details, personal information, vehicle details, trip details, driving history, etc. In the second phase, the data may be enhanced by the risk management platform, which can be configured to perform advanced analysis on the enhanced data. For example, the risk management platform may generate a risk profile corresponding to the individual based on the data. As another example, the risk management platform may supplement the data with other data, such as public records, asset details, or employment details. Moreover, the risk management platform may verify the identity of the individual, perform network analysis, etc. In the third phase, the risk management platform may employ a variety of algorithms (e.g., machine learning algorithms and artificial intelligence algorithms) to better understand the risk posed by the individual.

As shown in FIG. 6B, the risk management platform may rate the individual in a series of different categories. In some embodiments, the same categories are used to rate all individuals to ensure consistency. In other embodiments, different categories are used to rate the individuals based on, for example, the availability of data related to certain categories. Here, the risk management platform has rated the individual in ten different categories. However, those skilled in the art will recognize that any number of categories may be used. In some embodiments, the risk management platform may discover that certain combinations of categories (e.g., driving history, credit record, and likelihood of fraud) may be a better indicator of risk than any individual category.

In producing a score for each individual, the risk management platform may apply various heuristics (also referred to as “business rules”). In some embodiments, these heuristic(s) generate a quantitative metric for each category (e.g., a score of 710 in the likelihood of fraud category). In such embodiments, the risk management platform may combine the quantitative metrics in a certain manner to produce the overall score. For example, the risk management platform may average the quantitative metrics across all relevant/available categories. In other embodiments, these heuristic(s) generate a more qualitative metric for each category (e.g., an indication of whether the likelihood of fraud category should be considered good, moderate/intermediate, or poor). When someone (e.g., an administrator or a prospective renter herself) reviews a score, these qualitative metrics may be color-coded for easier review.

The risk management platform may also use proprietary data and/or models to improve the accuracy, precision, and reliability of the scores produced prospective renters. For example, the risk management platform may modify a score for a prospective renter based on the output from a model designed to consider rental history, telematics, online presence/activities, etc.

Thereafter, the risk management platform may improve how scores are generated over time. For example, the risk management platform could be configured to perform data refinement processes to discover what information consistently corresponds with the ultimate outcome of rental transactions (i.e., which items are actually predictors of risk), modeling processes to discover the effect of including a lesser/greater number of data types, machine learning processes, artificial intelligence processes, etc.

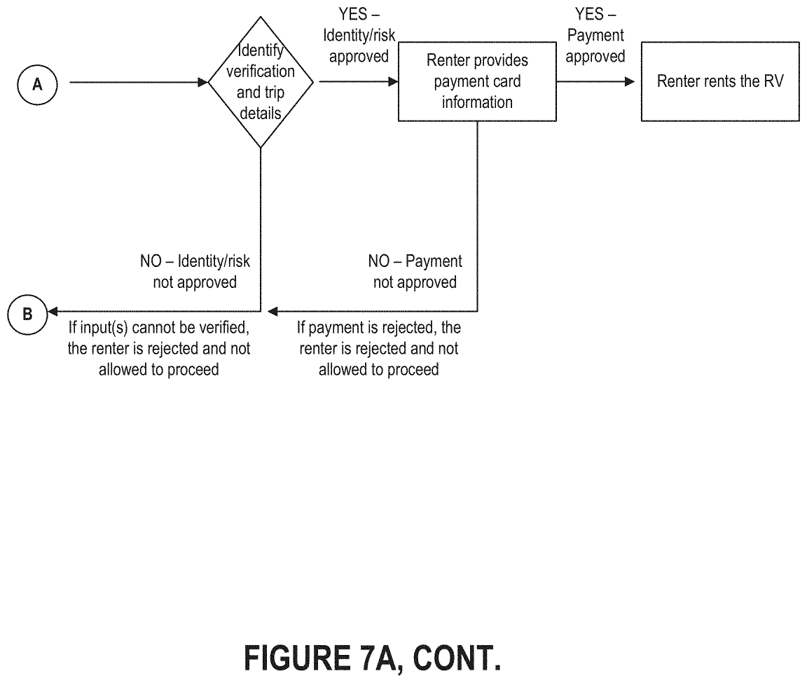

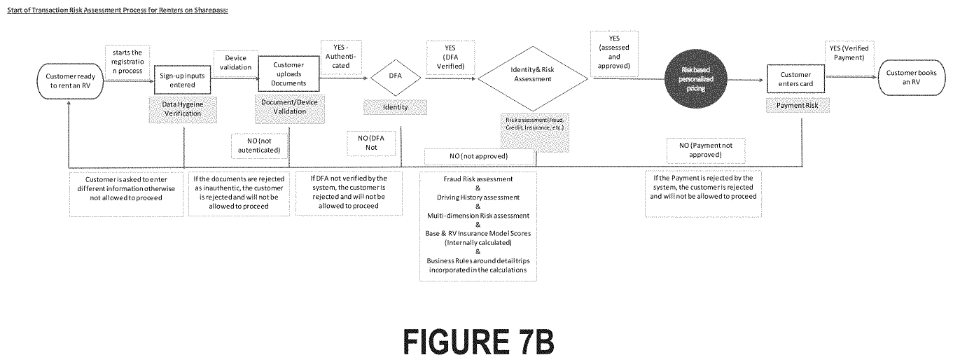

FIG. 7A includes a generalized illustration of a process for facilitating the completion of a rental transaction. To complete the rental transaction, a renter interfaces with a risk management platform to finalize a rental of a good owned by an owner. While embodiments may be described in the context of peer-to-peer sharing, those skilled in the art will recognize that similar technology may also be applied to rental transactions involving goods owned by, for example, an enterprise (e.g., a motor vehicle rental agency).

Initially, the renter decides that she is ready to rent an available good. Here, the process is described in the context of a recreational vehicle (RV). However, the process may be largely the same regardless of the type of good. For example, the process may be substantially similar regardless of whether the renter is renting an RV, boat, car/truck, or any other sharable item.

To initiate the registration process, the renter may be prompted to enter one or more sign-up inputs. For example, the risk management platform may generate an interface in which the renter can provide information such as name, email address, phone number, physical address, etc. After receiving the sign-up input(s), the risk management platform can determine whether the information can be verified. For example, the risk management platform may determine whether the email address is valid using, for example, a third-party data service (also referred to as a “data service” or “third-party data provider”). If the email address cannot be verified, the interface may prompt the renter to specify another email address before she is allowed to proceed.

If the email address can be verified, the risk management platform may then determine whether the phone number can be verified. For example, the risk management platform may cause a PIN to be delivered to the phone number (e.g., via text message). If the phone number cannot be verified (e.g., due to non-receipt of the PIN via the interface), the renter will not be allowed to proceed. If the phone number can be verified, however, the risk management platform may prompt the renter to upload an image of her driver's license. The risk management platform can verify the authenticity of the driver's license using, for example, a data service to determine whether the renter should be allowed to browse goods available for rent through the risk management platform. If the driver's license cannot be authenticated (e.g., due to a rejection as fake by the data service), the renter will not be allowed to proceed. If the driver's license can be authenticated, however, the risk management platform may conclude the registration process and initiate a reservation process.

The risk management platform will generally initiate the reservation process upon determining that the renter has successfully completed the registration process and a selection of a good has been made. Initially, the risk management platform can attempt to assess, identify, verify, and authenticate the interacting parties (e.g., the owner and the renter) to make sure these entities are valid. A combination of internal data (e.g., the data provided directly to the risk management platform by the interacting parties) and external data (e.g., the data acquired from data services) may be used to accomplish these tasks. In some embodiments, the risk management platform interfaces with a series of different data services to acquire the necessary external data.

If the identity of the renter cannot be verified (or the risk score is insufficient for approval), the renter will not be allowed to proceed. Whether the renter is allowed to proceed may depend on the number of positive results returned by the aforementioned services. For example, in some embodiments each service may need to return a positive result, while in other embodiments a predetermined percentage of services (e.g., at least 50%, 75%, etc.) may need to return a positive result.

In some embodiments, rather than simply verify renter identity, the risk management platform could instead determine whether to allow the reservation process to proceed based on the value of a score indicative of riskiness of renting to the renter. As noted above, the score may be calculated by the risk management platform using the same data that is necessary to verify renter identity.

If the identity of the renter can be authenticated (or the risk score is sufficient for approval), the renter may be prompted to provide payment information. For example, the risk management platform may generate an interface that prompts the renter to input information about a payment card (e.g., a credit card or debit card) or payment account with a money transfer service (e.g., PayPal, Google Wallet, etc.). The risk management platform may determine whether the payment information is valid using, for example, a payment processing service. If the payment information is deemed invalid (i.e., the payment is not approved), the renter will not be allowed to proceed. However, if the payment information is deemed valid (i.e., the payment is approved), the renter may be permitted to rent the RV.

FIG. 7A depicts one example of a process for registering for a rental service, and then reserving a good available through the rental service. While specific data services may be described for the purpose of illustration, those skilled in the art will recognize that other data services may be used in addition to, or instead of, those listed. Moreover, those skilled in the art will recognize that the risk management platform may interface with any number of data services to complete the process. For example, the risk management platform may interface with different data services to verify the sign-up inputs, driver's license, etc.

FIG. 7B depicts another example of a process for registering for a rental service, and then reserving a good available through the rental service. While the process of FIG. 7B is largely similar to the process of FIG. 7A, there are several differences. For example, rather than upload a driver's license, the prospective renter may upload another document (e.g., a passport). In such embodiments, the risk management platform may ensure that the other document can be verified (e.g., by a department of foreign affairs or a comparable agency/organization).

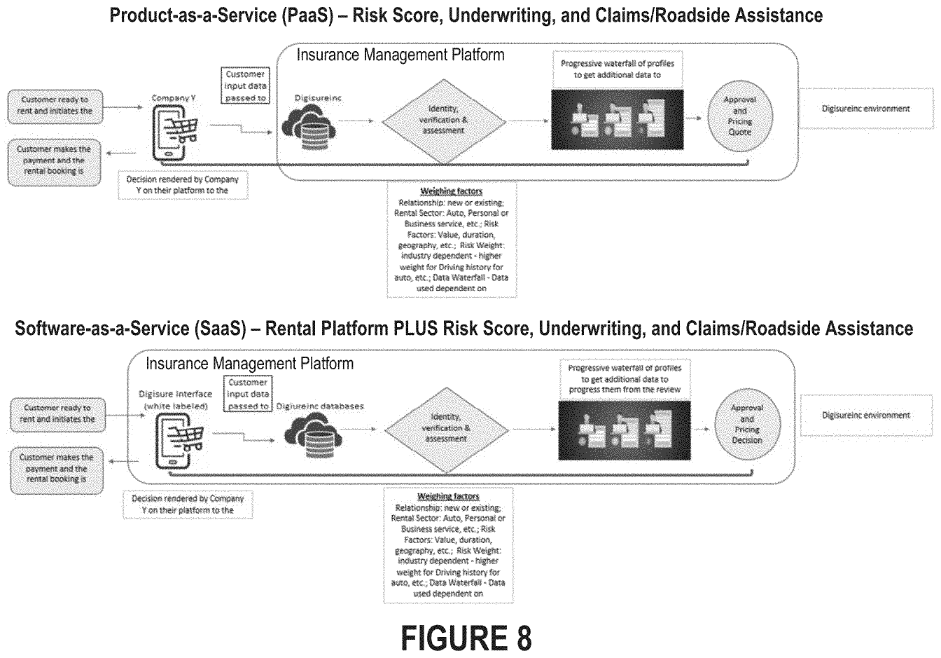

FIG. 8 illustrates how services offered by a risk management platform may be offered as a Product-as-a-Service (PaaS) or Software-as-a-Service (SaaS).

In a PaaS embodiment, prospective renters may interact with a provider via an online marketplace. A provider is an enterprise that is responsible for managing goods available for rent. The goods may belong to owners or the enterprise itself. Examples of providers include Airbnb®, Turo®, Getaround®, Outdoorsy®, and boatsetter®. Information acquired by the provider can be forwarded to the risk management platform, which can generate a risk score and pricing quote as described above. The provider may ultimately be responsible for deciding whether to rent a good to a particular renter, as well as what price the good should be rented at. However, these decisions may be based on the risk score and pricing quote generated by the risk management platform.

In a SaaS embodiment, prospective renters may interact directly with the risk management platform. However, interfaces generated by the risk management platform may be white labeled (e.g., with the name of a provider) for a more seamless experience. In such embodiments, the responsibility for deciding whether to rent a good to a particular renter, as well as what price the good should be rented at, may be made by the risk management platform rather than the provider.

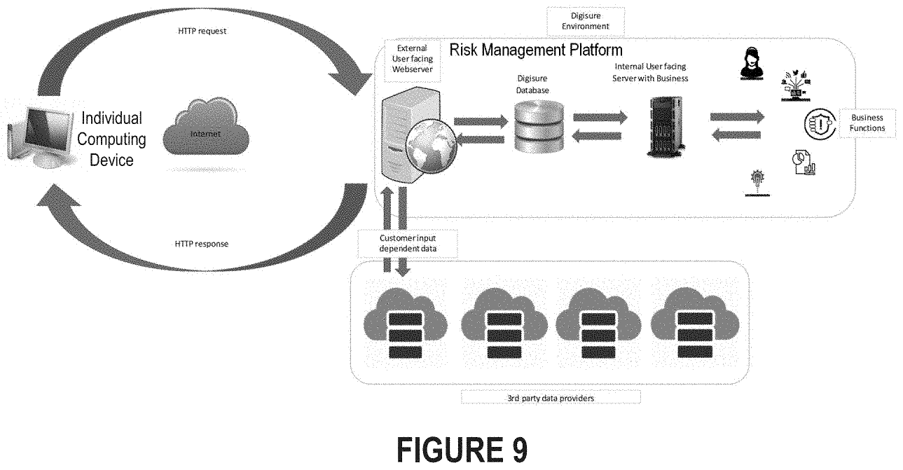

FIG. 9 depicts an example of a communication environment that includes a risk management platform with which individuals (e.g., prospective renters, owners, and/or administrators) may interact. In some embodiments, the risk management platform may reside on a network-accessible server. When an individual interacts with the risk management platform (e.g., by accessing an interface generated by the risk management platform), communications delivered to the network-accessible server may be transmitted in Hypertext Transfer Protocol (HTTP) format. Communications delivered to the computing device associated with the individual may be transmitted in HTTP format or JavaScript Object Notation (JSON) format.

The network-accessible server, meanwhile, may be communicatively coupled to one or more other sources of data. Here, for example, the network-accessible server is communicatively coupled to a series of third-party data providers. These connections allow the risk management platform to receive data from, and send data to, these third-party data providers.

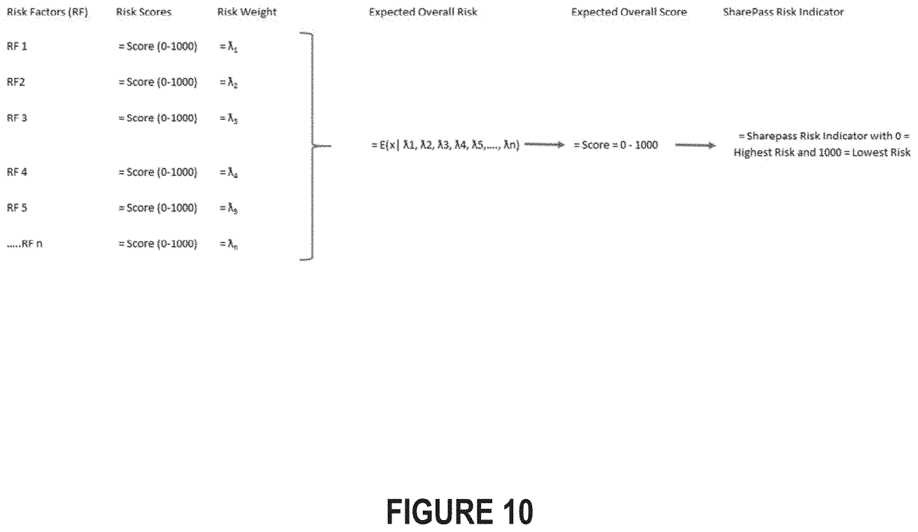

FIG. 10 illustrates how a risk management platform can generate a score for a prospective renter indicative of risk in renting a good to the prospective renter by separately weighing a series of risk factors. Each risk factor may be associated with a different risk-relevant category. Examples of risk-relevant categories include fraud history, credit history, claims history, usage behavior, employment history, social networking history, etc.

The risk management platform may produce a risk score for any combination of these risk-relevant categories. Then, the risk management platform may assign a weight to each risk score. Each weight could be based on, for example, the degree of correlation between the corresponding risk-relevant category and the likelihood of a rental transaction being completed without issue. Weights may be assigned on an individual basis (e.g., based on the corresponding prospective renter's prior rental activities) or a cohort basis. For instance, each prospective renter may be associated with a cohort of other individuals with whom she shares a characteristic in common, such as age, location, credit history, driving history, employment history, etc. The same weights may be used for all members of the cohort. Alternatively, the same weights may be used for all prospective renters who have an account with the risk management platform. In some embodiments, the weights are varied by the risk management platform over time responsive to discovering the degree of correlation between the corresponding risk-relevant category and the likelihood of a rental transaction being completed without issue.

The risk management platform will often be responsible for underwriting two main risks: insurance risk and credit risk. Insurance risk is underwritten for the purpose of insuring the goods that are shared, while credit risk is underwritten for the purpose of ensuring that payments come through if there is a claim (e.g., for the deductible, security deposit, value of the good, etc.). The data that can be considered is defined by regulators based on which of these risk categories the risk management platform is presently underwriting. The risk management platform may simply assign a weight of zero to those characteristics (e.g., age, location, credit history, driving history, or employment history) that cannot be considered while underwriting a policy for a particular risk category.

By combining the weighted risk factors, the risk management platform can generate an expected overall risk for each prospective renter. Moreover, the risk management platform may convert the expected overall risk into an expected overall score. The expected overall score may be more readily understandable by the prospective renter. For example, the expected overall score may be a whole number between 0 and 1,000. The expected overall score may also permit distinctions to be more easily drawn (e.g., by owners or administrators) between multiple prospective renters.

### Illustrative Examples

Many of the embodiments described herein are in terms of data collection, risk assessment, and pricing in a general sense. However, the technology may be employed in various scenarios.

For example, in one illustrative example, the risk management platform may be associated with an online marketplace for RVs that resides on a mobile phone in the form of a mobile application. The online marketplace may be associated with a provider or the risk management platform itself. In such embodiments, a prospective renter may be permitted to approach an RV available for rent, initiate the mobile application executing on her mobile phone, scan a readable item affixed to the RV, and complete a rental transaction (including dynamic insurance pricing) via the mobile application.

The readable item may include machine-readable elements, human-readable elements, structural elements, or some combination thereof. Machine-readable elements are codes that are designed to be read/interpreted by a computing device. Machine-readable elements, such as bar codes and QR codes, can include extractable information, such as various good properties and characteristics. Human-readable elements, such as text and images, may be identified using various optical character recognition (OCR) techniques. Structural elements (also referred to as “formatting elements”), such as horizontal lines and solid bars, may also be used to identify goods.

Machine-readable elements, human-readable elements, and structural elements (collectively referred to as “the elements”) may convey information that is useful in identifying/describing the corresponding good. The information can include good type, good characteristics, owner name, etc. For example, the risk management platform may identify a digital record upon examining an image of a QR code affixed to the good that was taken by a prospective renter. As another example, the risk management platform may identify a digital record upon examining an image of a license plate affixed to the good that was taken by a prospective renter.

Embodiments of the risk management platform may also be configured to facilitate the input/generation of cross-vertical/platform user reviews and/or “good rental citizen” information as part of the risk scores.

### Processing System

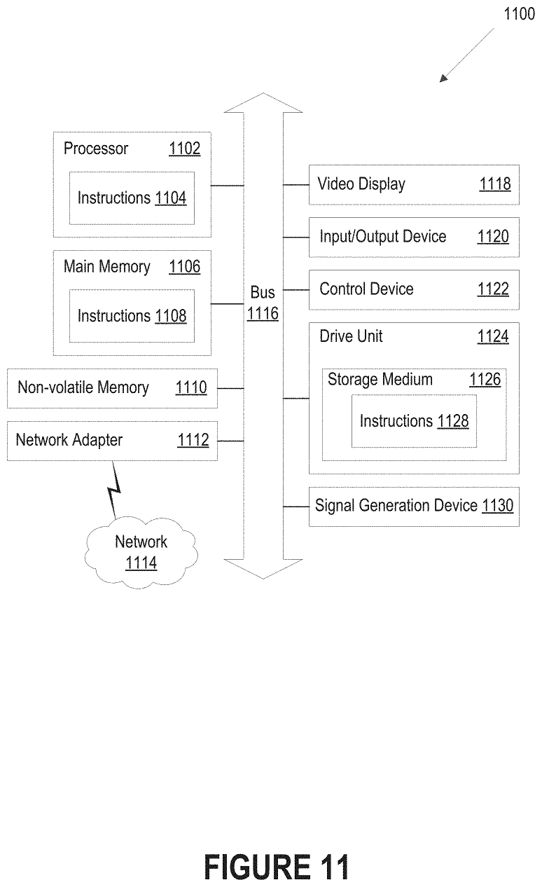

FIG. 11 is a block diagram illustrating an example of a processing system 1100 in which at least some operations described herein can be implemented. For example, some components of the processing system 1100 may be hosted on a computing device that includes a risk management platform (e.g., risk management platform 202 of FIG. 2).

The processing system 1100 may include one or more central processing units (“processors”) 1102, main memory 1106, non-volatile memory 1110, network adapter 1112 (e.g., network interface), video display 1118, input/output devices 1120, control device 1122 (e.g., keyboard and pointing devices), drive unit 1124 including a storage medium 1126, and signal generation device 1130 that are communicatively connected to a bus 1116. The bus 1116 is illustrated as an abstraction that represents one or more physical buses and/or point-to-point connections that are connected by appropriate bridges, adapters, or controllers. The bus 1116, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

The processing system 1100 may share a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the processing system 1100.

While the main memory 1106, non-volatile memory 1110, and storage medium 1126 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 1128. The term “machine-readable medium” and “storage medium” shall also be taken to include any medium that is capable of storing, encoding, or carrying a set of instructions for execution by the processing system 1100.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 1104, 1108, 1128) set at various times in various memory and storage devices in a computing device. When read and executed by the one or more processors 1102, the instruction(s) cause the processing system 1100 to perform operations to execute elements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 1110, floppy and other removable disks, hard disk drives, optical disks (e.g., Compact Disk Read-Only Memory (CD-ROMS), Digital Versatile Disks (DVDs)), and transmission-type media such as digital and analog communication links.

The network adapter 1112 enables the processing system 1100 to mediate data in a network 1114 with an entity that is external to the processing system 1100 through any communication protocol supported by the processing system 1100 and the external entity. The network adapter 1112 can include a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 1112 may include a firewall that governs and/or manages permission to access/proxy data in a computer network, and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall may additionally manage and/or have access to an access control list that details permissions including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

### Remarks

The foregoing description of various embodiments of the technology has been provided for the purposes of illustration and description. It is not intended to be exhaustive or to limit the technology to the precise forms disclosed. Many modifications and variations will be apparent to one skilled in the art. Embodiments were chosen and described in order to best describe the principles of the invention and its practical applications, thereby enabling those skilled in the relevant art to understand the subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. A computer-implemented method for estimating risk associated with an individual involved in a rental transaction, the method comprising:
receiving, by a processor, first input indicative of a selection of a good to be shared by an owner with a renter as part of a rental transaction;
acquiring, by the processor, second input indicative of personal information provided by an individual via an interface;
acquiring, by the processor, third input indicative of risk-related information from at least one data service accessible via a network;
generating, by the processor, a profile for the individual that includes the personal information and the risk-related information;
producing, by the processor, a risk score based on the personal information, the risk-related information, or any combination thereof,
wherein the risk score is a measure representing risk of the rental transaction due to involvement by the individual; and
calculating, by the processor, a personalized price for the rental transaction based on the risk score.

2. The computer-implemented method of claim 1, further comprising:
for each data service of the at least one data services,
interfacing, by the processor, with a corresponding application programming interface to acquire risk-related information.

3. The computer-implemented method of claim 1, wherein the individual is the renter of the shared good.

4. The computer-implemented method of claim 1, wherein the individual is the owner of the shared good.

5. The computer-implemented method of claim 1, further comprising:
acquiring, by the processor, fourth input indicative of behavioral information associated with the individual; and
establishing, by the processor, a behavioral characteristic of the individual by examining the fourth input,
wherein the risk score is further based on the behavioral characteristic.

6. The computer-implemented method of claim 5, wherein the behavioral characteristic is representative of whether past rental transactions involving the individual have been completed without issue.

7. The computer-implemented method of claim 1, further comprising:
associating, by the processor, the individual with a risk classification based on the risk score.

8. The computer-implemented method of claim 7, wherein the risk classification is one of a series of risk classifications, and wherein each risk classification in the series of risk classifications is associated an upper score threshold and a lower score threshold.

9. The computer-implemented method of claim 7, wherein the risk classification is determined by stratifying a pool of individuals based on corresponding risk scores.

10. The computer-implemented method of claim 1, further comprising:
updating, by the processor, the profile continually over time as the individual completes additional rental transactions.

11. An electronic device comprising:
a memory that includes instructions for dynamically calculating an appropriate price for an insurance service related to a rental transaction,
wherein the instructions, when executed by a processor, cause the processor to:
acquire input indicative of a selection of a good to be shared by an owner with a renter as part of the rental transaction and a term of the rental transaction;
identify the owner associated with the good by accessing an ownership database that associates owners with goods offered for rent by a network-accessible marketplace;
for the renter,
acquire first data indicative of personal information provided by the renter and second data indicative of risk-related information provided by a first data service, and
produce a first risk score based on the first data, the second data, or any combination thereof;
for the owner,
acquire third data indicative of personal information provided by the owner and fourth data indicative of risk-related information provided by a second data service, and
produce a second risk score based on the third data, the fourth data, or any combination thereof; and
calculate a price for the rental transaction based on the first and second risk scores.

12. The electronic device of claim 11, wherein the term of the rental transaction is a desired duration of the rental transaction.

13. The electronic device of claim 11, wherein the instructions further cause the processor to:
cause display of the first risk score and the price on a first interface accessible to the renter; and
cause display of the second risk score and the price on a second interface accessible to the owner.

14. The electronic device of claim 13, wherein the first and second interfaces are associated with the network-accessible marketplace.

15. The electronic device of claim 11, wherein the first and second data services are a same data service.

16. The electronic device of claim 11, wherein the instructions further cause the processor to:
receive an image of a readable item associated with the good that is taken by the renter,
wherein the input is at least partially derived based on an analysis of the readable item included in the image.

17. The electronic device of claim 16, wherein the readable item includes one or more machine-readable elements, one or more human-readable elements, one or more structural elements, or any combination thereof.

18. A computer-implemented method comprising:
generating, by a processor, an interface accessible to a renter;
causing, by the processor, display of multiple goods offered for rent by a network-accessible marketplace on the interface;
interfacing, by the processor, with a data service via an application programming interface;
acquiring, by the processor, risk-related information associated with the renter from the data service;
receiving, by the processor, a series of inputs, each input of the series of inputs specifying a good to be shared with the renter as part of a rental transaction and a desired duration of the rental transaction;
for each input of the series of inputs,
producing, by the processor, a risk score based on the risk-related information, the good, and the desired duration; and
calculating, by the processor, a price for the rental transaction based on the risk score.

19. The computer-implemented method of claim 18, further comprising:
examining, by the processor, reviews submitted by owners involved in past rental transactions with the renter,
wherein the personalized price is further based on the reviews.

20. The computer-implemented method of claim 18, wherein the network-accessible marketplace is associated with a peer-to-peer sharing service, and wherein the multiple goods are associated with multiple owners.

21. The computer-implemented method of claim 18, further comprising:
associating, by the processor, the renter with a risk classification based on a first risk score associated with a first input of the series of inputs; and
assessing, by the processor, whether the risk classification should be modified in response to producing the risk score for each subsequent input of the series of inputs.
